(19) United States
(12) Patent Application Publication
(10) Pub. No.: US 2012/0146949 A1
(43) Pub. Date: Jun. 14, 2012

(54) METHOD FOR POSITIONING COMPENSATION OF A TOUCH OBJECT ON A TOUCH SURFACE OF A SCREEN AND OPTICAL TOUCH MODULE THEREOF

(76) Inventor: Yu-Yen Chen, New Taipei City (TW)

(21) Appl. No.: 13/089,331

(22) Filed: Apr. 19, 2011

(30) Foreign Application Priority Data
Dec. 8, 2010 (TW) 099142804

(51) Int. Cl. G06F 3/042

(52) U.S. Cl. 345/175

(57) ABSTRACT

A method for positioning compensation of a touch object on a touch surface of a screen is disclosed. The method includes disposing a mark unit on a side frame of a screen, recording an ideal pixel position of the mark unit in an ideal side-frame image, capturing an actual side-frame image toward a touch surface of the screen, and determining whether to adjust relations between pixel positions and camera angles of a touch object according to the ideal pixel position and an actual pixel position of the mark unit in the actual side-frame image.

### BACKGROUND OF THE INVENTION

1. Field of the Invention

The invention relates to a compensation method and a related optical touch module, and more specifically, to a method for positioning compensation of a touch object on a touch surface of a screen and a related optical touch module.

2. Description of the Prior Art

For a conventional optical touch module, positioning of a touch object on a touch surface of a touch screen is achieved by position comparison of the touch object and a side frame of the touch screen in a side-frame image captured by cameras and calculation based on trigonometric functions.

Please refer to FIG. 1, which is a diagram of positioning a touch object 10 according to the prior art. As shown in FIG. 1, a first camera 12 and a second camera 14 are disposed at upper-left and upper-right corners of a touch surface 16, respectively. The position of the first camera 12 is set as an origin (i.e. (0, 0)), the distance from the first camera 12 to the second camera 14 is set as W, the camera angle of the touch object 10 relative to the first camera 12 is set as θ₁, and the camera angle of the touch object 10 relative to the second camera 12 is set as θ₂. Thus, the planar coordinate of the touch object 10 on the touch surface 16 can be calculated according to the following math functions.

X=[W*tan(θ₂)]/[tan (θ₁)+tan (θ₂)]

Y=X*tan (θ₁)

As known above, positioning accuracy of the touch object on the touch surface is determined by whether the camera angle of the touch object relative to the camera is correct. However, after the optical touch module is used over a period of time, offset of the camera from its original shooting angle usually occurs due to some factor (e.g. the optical touch module receiving sudden impact or poor assembly of the optical touch module). As a result, offset of the camera angle of the touch object relative to the camera occurs accordingly so as to make optical touch positioning for the touch object incorrect. Thus, it is required to adjust the shooting angle of the camera frequently, so as to cause the optical touch module much inconvenience in practical application.

### SUMMARY OF THE INVENTION

An embodiment of the invention provides a method for positioning compensation of a touch object on a touch surface of a screen. The method includes disposing a mark unit on a side frame of a screen, recording an ideal pixel position of the mark unit in an ideal side-frame image, capturing an actual side-frame image toward a touch surface of the screen, and determining whether to adjust relations between pixel positions and camera angles of a touch object according to the ideal pixel position and an actual pixel position of the mark unit in the actual side-frame image.

An embodiment of the invention further provides an optical touch module. The optical touch module includes a screen, a mark unit, at least one image capturing device, and an image processing device. The screen has a touch surface and a side frame. The mark unit is disposed on the side frame. The image capturing device is disposed on the screen for capturing an actual side-frame image toward the touch surface. The image processing device is disposed in the screen and electrically connected to the image capturing device. The image processing device includes a recording unit and a processing unit. The recording unit is used for recording an ideal pixel position of the mark unit in an ideal side-frame image. The processing unit is used for determining whether to adjust relations between pixel positions and camera angles of a touch object according to the ideal pixel position and an actual pixel position of the mark unit in the actual side-frame image.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of positioning a touch object according to the prior art.

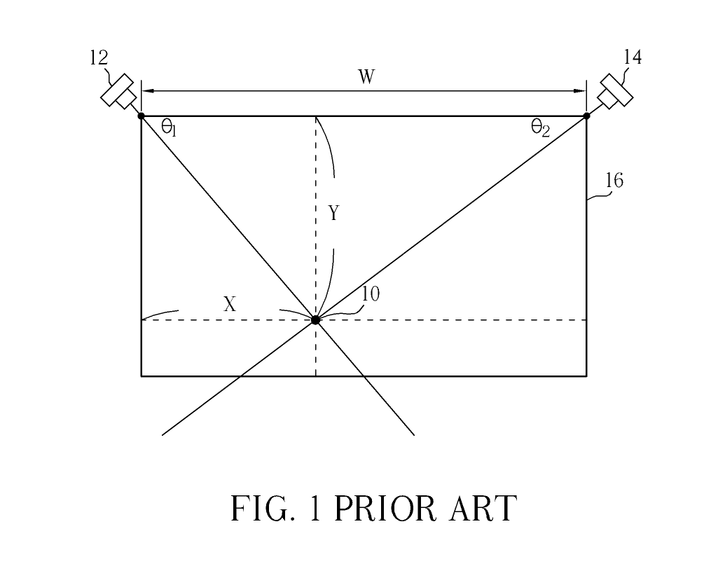

FIG. 2 is a diagram of an optical touch module according to an embodiment of the invention.

FIG. 3 is a functional block diagram of an image processing device in FIG. 2.

FIG. 4 is a flowchart of a method for utilizing the optical touch module to perform positioning compensation of a touch object on a touch surface of a screen.

FIG. 5 is a diagram of relations between pixel positions and camera angles of a mark unit in FIG. 2.

FIG. 6 is a diagram of an image capturing device in FIG. 5 rotating a shifted angle clockwise.

### DETAILED DESCRIPTION

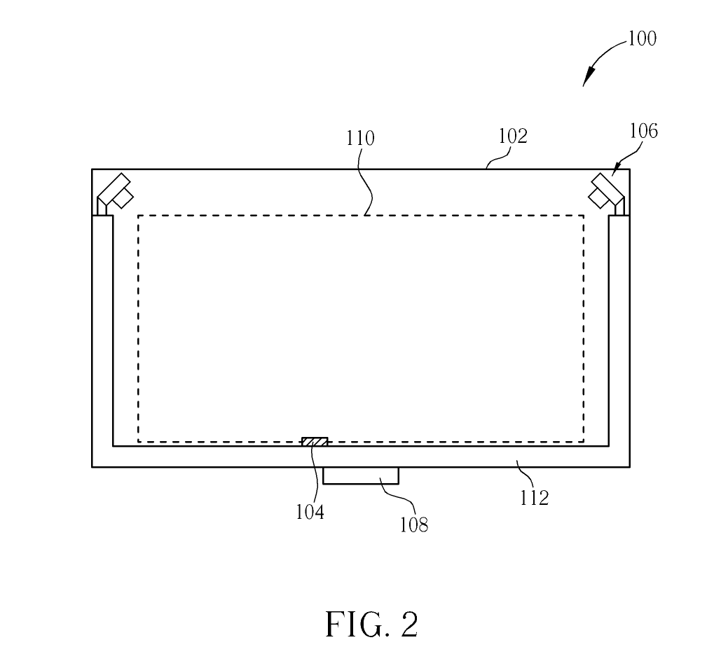

Please refer to FIG. 2, which is a diagram of an optical touch module 100 according to an embodiment of the invention. As shown in FIG. 2, the optical touch module 100 includes a screen 102, a mark unit 104, at least one image capturing device 106 (two shown in FIG. 2), and an image processing device 108. The screen 102 has a touch surface 110 for a user to perform touch operations. The mark unit 104 is disposed on a side frame 112 of the screen 102. In this embodiment, the mark unit 104 can be a symbol (but not limited thereto), the color of which is different from that of the side frame 112 for the following identification of a pixel position of the mark unit 104. It should be noted that the mark unit 104 can also be other component having the same identification effect, such as a reflective member, a light emitting device (e.g. a light emitting diode), etc. The image capturing devices 106 are disposed at the upper-left and upper-right corners of the screen 102 respectively and face the touch surface 110. In such a manner, the image capturing devices 14 can capture corresponding side-frame images for optical touch positioning of a touch object (e.g. a stylus, a user's finger, etc.) on the touch surface 110 of the screen 102. The image capturing device 106 is preferably a camera.

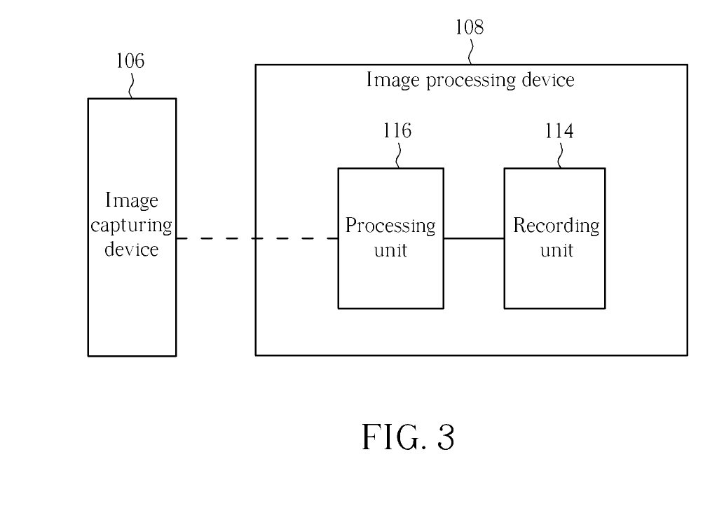

Please refer to FIG. 3, which is a functional block diagram of the image processing device 108 in FIG. 2. The image processing device 108 is disposed on the screen 102 and electrically connected to the image capturing device 106. As shown in FIG. 3, the image processing device 108 includes a recording unit 114 and a processing unit 116. The image processing device 108 is preferably a hardware, a software, or a firmware for performing related image processing. The recording unit 114 is used for recording an ideal pixel position of the mark unit 104 in an ideal side-frame image. The processing unit 116 is used for determining whether to adjust relations between pixel positions and camera angles of a touch object according to the ideal pixel position and an actual pixel position of the mark unit 104 in an actual side-frame image.

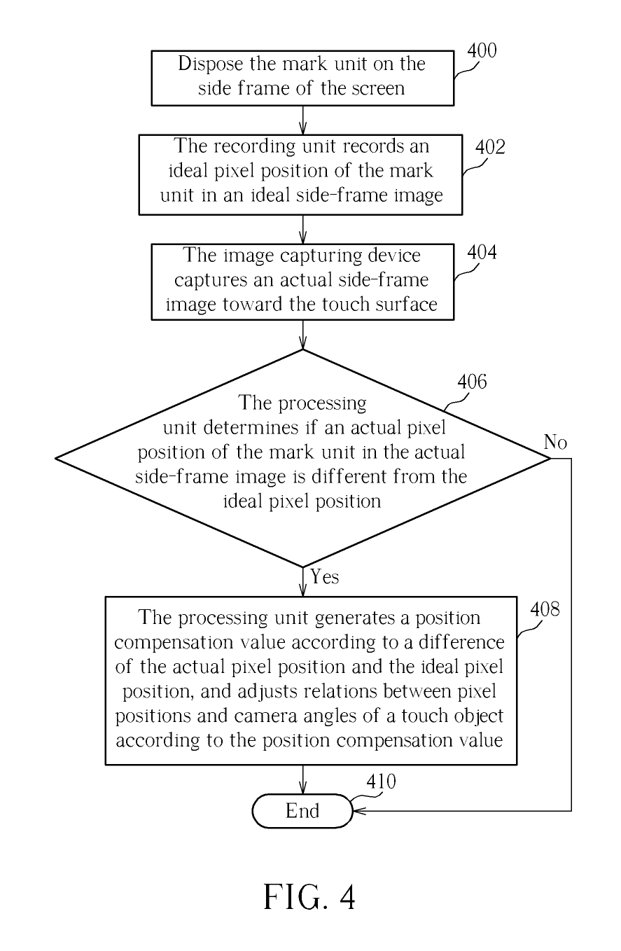

Next, please refer to FIG. 4, which is a flowchart of a method for utilizing the optical touch module 100 in FIG. 2 to perform positioning compensation of a touch object on the touch surface 110 of the screen 102. The method includes the following steps.

Step 400: Dispose the mark unit 104 on the side frame 112 of the screen 102;

Step 402: The recording unit 114 records an ideal pixel position of the mark unit 104 in an ideal side-frame image;

Step 404: The image capturing device 106 captures an actual side-frame image toward the touch surface 110;

Step 406: The processing unit 116 determines if an actual pixel position of the mark unit 104 in the actual side-frame image is different from the ideal pixel position; if so, go to Step 408; if not, go to Step 410;

Step 408: The processing unit 116 generates a position compensation value according to a difference of the actual pixel position and the ideal pixel position, and adjusts relations between pixel positions and camera angles of a touch object according to the position compensation value;

Step 410: End.

The said relations between the pixel positions and the camera angles of the touch object is predetermined as a reference for plane positioning of the touch object before the optical touch module 100 leaves the factory. For example, in a side-frame image with a lateral resolution (e.g. 640 pixels) captured by the image capturing device 106 toward the touch surface 110, the pixel positions respectively corresponding to the camera angles of 0 and 90 degrees can be set as a boundary condition of the said relations, such as the 10^{th} pixel position corresponding to the camera angle of 0 degree and the 640^{th} pixel position corresponding to the camera angle of 90 degrees. Thus, as long as the pixel position of the touch object in the side-frame image is known, the current camera angle of the touch object relative to the image capturing device 106 can be calculated by an interpolation method according to the said relations since the said relations are linear. The camera angle mentioned above can be defined as an angle included between a target object (i.e. the touch object or the mark unit 104) and two image capturing devices 106 in FIG. 2. In such a manner, the plane coordinate of the touch object on the touch surface 110 can be calculated according to the math functions mentioned above so as to complete plane positioning of the touch object.

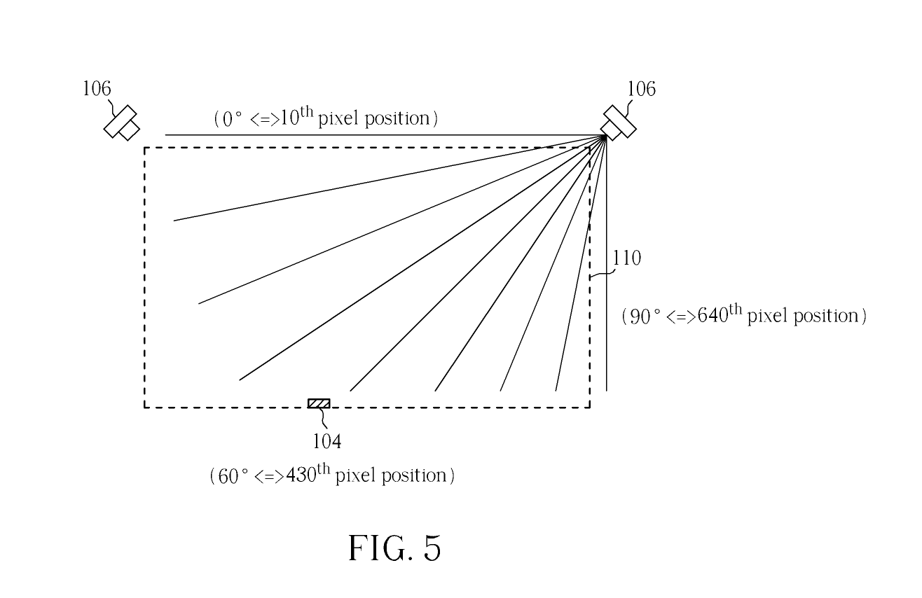

More detailed description for the said steps is provided as follows in view of positioning compensation between the image capturing device 106 disposed at the upper-right corner of the screen 102 and the image processing device 108. As for positioning compensation between the image capturing device 106 disposed at the upper-left corner of the screen 102 and the image processing device 108, the related description can be reasoned by analogy and therefore omitted herein. As known in Step 400, the mark unit 104 is disposed at a position of the side frame 112 corresponding to a specific camera angle (e.g. 60 degrees) first, such as before the optical touch module 100 leaves the factory. Subsequently, the recording unit 114 records the ideal pixel position of the mark unit 104 in the ideal side-frame image (Step 402), wherein the ideal side-frame image is a side-frame image captured by the image capturing device 106 toward the touch surface 110 when the image capturing device 106 is not offset from its original shooting angle. In this condition, the relations between the pixel positions and the camera angles of the mark unit 104 can be as shown in FIG. 5, which is a diagram of the relations between the pixel positions and the camera angles of the mark unit 104 in FIG. 2. That is, as shown in FIG. 5, in the condition that the image capturing device 106 is not offset from its original shooting angle, the 10^{th} pixel position corresponds to the camera angle of 0 degree, and the 640^{th} pixel position corresponds to the camera angle of 90 degrees, the mark unit 104 is located at the 430^{th} pixel position corresponding to the camera angle of 60 degrees.

When a user utilizes a touch object (e.g. the user's finger or a stylus) to perform touch operations on the touch surface 110, the image capturing device 106 captures the actual side-frame image toward the touch surface 110 (Step 404). The actual side-frame image is a side-frame image captured by the image capturing device 100 toward the touch surface 110 when the optical touch module 100 is used, wherein the actual side-frame image may be inconsistent with the ideal side-frame image if the image capturing device 106 has been offset from its original shooting angle.

After the actual side-frame image is captured to obtain the actual pixel position of the mark unit 104 in the actual side-frame image, the processing unit 116 determines whether the actual pixel position of the mark unit 104 is different from the ideal pixel position (Step 406). If the processing unit 116 determines the actual pixel position of the mark unit 104 is consistent with the ideal pixel position, the processing unit 116 determines the image capturing device 106 is not offset from its original shooting angle, and then directly performs Step 410 to finish the positioning compensation of the optical touch module 100.

On the other hand, if the processing unit 116 determines the actual pixel position of the mark unit 104 is different from the ideal pixel position, the processing unit 116 determines the image capturing device 106 has been offset from its original shooting angle due to some factor (e.g. the optical touch module 100 receiving sudden impact or poor assembly of the optical touch module 100). At this time, for preventing incorrect plane positioning of the touch object, the processing unit 116 generates the position compensation value according to the difference of the actual pixel position and the ideal pixel position, and then adjusts the relations between the pixel positions and the camera angles of the touch object according to the position compensation value (Step 408), so as to complete the positioning compensation of the optical touch module 100.

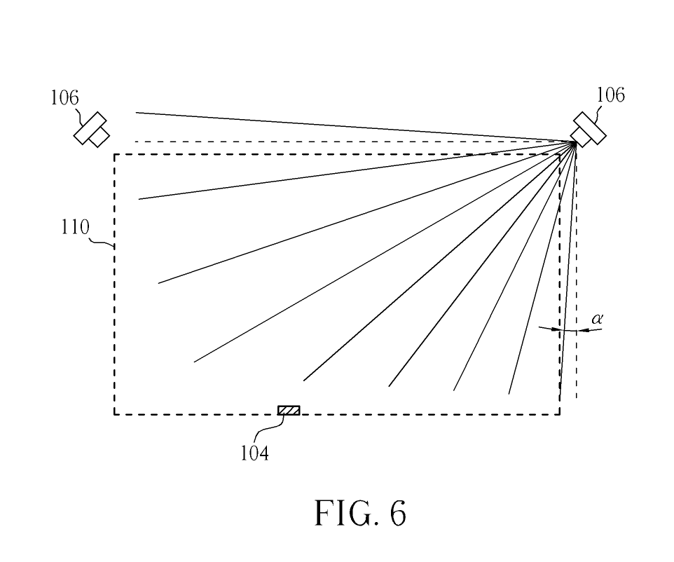

The following description is exemplified in the condition that the 10^{th} pixel position corresponds to the camera angle of 0 degree, the 640^{th} pixel position corresponds to the camera angle of 90 degrees, and the ideal pixel position of the mark unit 104 is the 430^{th} pixel position. At this time, if the actual pixel position of the mark unit 104 is the 437^{th} pixel position, it means that the pixel position of the mark unit 104 has been offset rightward from the ideal pixel position by 7 pixels. That is, the image capturing device 106 has been rotated clockwise from its original shooting angle as shown in FIG. 5 by an offset angle α (as shown in FIG. 6). Thus, the processing unit 116 calculates the position compensation value according to a difference of the actual pixel position and the ideal pixel position (437−430=+7), and then adjusts the relations between the pixel positions and the camera angles of the touch object according to the position compensation value. In other words, the boundary condition of the said relations is changed from the original boundary condition that the 10^{th} pixel position corresponds to the camera angle of 0 degree and the 640^{th} pixel position corresponds to the camera angle of 90 degrees, to a new boundary condition that the 17^{th} pixel position corresponds to the camera angle of 0 degree and the 647^{th} pixel position corresponds to the camera angle of 90 degrees. As for relations between other pixel positions and camera angles, they can be calculated accordingly by an interpolation method according to the new boundary condition. It should be mentioned that the processing unit 116 can also calculate that the offset angle α is equal to 1 degree ((90/630)*7) according to the position compensation value.

On the other hand, if the image capturing device 106 is rotated counterclockwise from its original shooting angle as shown in FIG. 5 by 1 degree, it means that the actual pixel position of the image capturing device 106 is the 423^{th} pixel position. Similarly, at this time, the processing unit 116 calculates the position compensation value according to a difference of the actual pixel position and the ideal pixel position (423−430=−7), and then adjusts the relations between the pixel positions and the camera angles of the touch object according to the position compensation value. In other words, the boundary condition of the said relations is changed from the original boundary condition that the 10^{th} pixel position corresponds to the camera angle of 0 degree and the 640^{th} pixel position corresponds to the camera angle of 90 degrees, to a new boundary condition that the 3^{rd} pixel position corresponds to the camera angle of 0 degree and the 633^{th} pixel position corresponds to the camera angle of 90 degrees. As for relations between other pixel positions and camera angles, they can be calculated accordingly by an interpolation method according to the new boundary condition.

In brief, no matter the image capturing device 106 is rotated clockwise or counterclockwise, the image processing device 108 can calculate a corresponding position compensation value according to comparison of the actual pixel position and the ideal pixel position of the mark unit 104, so as to achieve the purpose of performing optimal adjustment on the relations between the pixel positions and the camera angles of the touch object.

Furthermore, the said settings for the lateral resolution (i.e. number of pixels) of the side-frame image, the boundary condition of the relations between the pixel positions and the camera angles of the touch object, and the ideal pixel position of the mark unit 104 are not limited to the said embodiment. That is, all designs for utilizing position comparison of a mark unit to perform position compensation of a touch object may fall within the scope of the invention. As for the related value variation, it depends on the practical application of the optical touch module 100.

The said positioning compensation process can be applied to the following image processing of the optical touch module 100. For example, the optical touch module 100 can perform optimal position compensation on the relations between the pixel positions and the camera angles of the touch object by automatically performing the said steps when being started every time. Thus, even if offset of the original shooting angle of the image capturing device 106 occurs due to some factor (e.g. the optical touch module 100 receiving sudden impact or poor assembly of the optical touch module 100) after the optical touch module 100 leaves the factory, the optical touch module 100 can automatically adjust the relations between the pixel positions and the camera angles of the touch object via performing the said steps, so that the processing unit 116 can perform optical touch positioning of a touch object on the touch surface 110 accurately according to the adjusted relations. As a result, incorrect plane positioning of the touch object caused by the offset of the original shooting angle of the image capturing device 106 can be avoided accordingly, so as to enhance accuracy of the optical touch module 10 in optical touch positioning. As for related calculation of plane positioning, it has been disclosed in the aforementioned prior art and then is omitted herein.

Compared with the prior art, the optical touch module provided by the invention utilizes a method for disposing the mark unit on the side frame of the screen and comparing its ideal pixel position with its actual pixel position, to determine whether to adjust relations between pixel positions and camera angles of a touch object. In such a manner, even if offset of the original shooting angle of the image capturing device occurs due to some factor (e.g. the optical touch module receiving sudden impact or poor assembly of the optical touch module) after the optical touch module leaves the factory, the optical touch module can still perform the said steps to prevent incorrect plane positioning of the touch object caused by the offset of the original shooting angle of the image capturing device. Thus, the problem that the shooting angle of the image capturing device needs to be adjusted frequently can be solved accordingly, and accuracy of the optical touch module in optical touch positioning can be further enhanced.

Those skilled in the art will readily observe that numerous modifications and alterations of the device and method may be made while retaining the teachings of the invention.

What is claimed is:

1. A method for positioning compensation of a touch object on a touch surface of a screen, the method comprising:
disposing a mark unit on a side frame of a screen;
recording an ideal pixel position of the mark unit in an ideal side-frame image;
capturing an actual side-frame image toward a touch surface of the screen; and
determining whether to adjust relations between pixel positions and camera angles of a touch object according to the ideal pixel position and an actual pixel position of the mark unit in the actual side-frame image.

2. The method of claim 1, wherein determining whether to adjust the relations between the pixel positions and the camera angles of the touch object according to the ideal pixel position and the actual pixel position of the mark unit in the actual side-frame image comprises:
generating a position compensation value according to a difference of the actual pixel position and the ideal pixel position when determining the actual pixel position is different from the ideal pixel position; and
adjusting the relations between the pixel positions and the camera angles of the touch object according to the position compensation value.

3. The method of claim 1, wherein disposing the mark unit on the side frame of the screen comprises:
utilizing a symbol formed on the side frame as the mark unit, a color of the symbol being different from a color of the side frame.

4. The method of claim 1, wherein disposing the mark unit on the side frame of the screen comprises:
utilizing light as the mark unit, the light being emitted from a light emitting device disposed on the side frame.

5. The method of claim 1, wherein disposing the mark unit on the side frame of the screen comprises:
utilizing a reflective member disposed on the side frame as the mark unit.

6. The method of claim 1 further comprising:
performing optical touch positioning of the touch object on the touch surface according to the adjusted relations between the pixel positions and the camera angles of the touch object.

7. An optical touch module comprising:
a screen having a touch surface and a side frame;
a mark unit disposed on the side frame;
at least one image capturing device disposed on the screen for capturing an actual side-frame image toward the touch surface; and
an image processing device disposed in the screen and electrically connected to the image capturing device, the image processing device comprising:
a recording unit for recording an ideal pixel position of the mark unit in an ideal side-frame image; and
a processing unit for determining whether to adjust relations between pixel positions and camera angles of a touch object according to the ideal pixel position and an actual pixel position of the mark unit in the actual side-frame image.

8. The optical touch module of claim 7, wherein the processing unit is used for generating a position compensation value according to a difference of the actual pixel position and the ideal pixel position when determining the actual pixel position is different from the ideal pixel position, and is used for adjusting the relations between the pixel positions and the camera angles of the touch object according to the position compensation value.

9. The optical touch module of claim 7, wherein the mark unit is a symbol, and a color of the symbol is different from a color of the side frame.

10. The optical touch module of claim 7, wherein the mark unit is a light emitting device.

11. The optical touch module of claim 10, wherein the light emitting device is a light emitting diode.

12. The optical touch module of claim 7, wherein the mark unit is a reflective member.

13. The optical touch module of claim 7, wherein the processing unit is further used for performing optical touch positioning of the touch object on the touch surface according to the adjusted relations between the pixel positions and the camera angles of the touch object.
